(19) United States
(12) Patent Application Publication
(10) Pub. No.: US 2015/0304321 A1
(43) Pub. Date: Oct. 22, 2015

(54) AN IMAGE MANAGEMENT SYSTEM AND AN IMAGE MANAGEMENT METHOD BASED ON FINGERPRINT AUTHENTICATION

(71) Applicant: WWTT TECHNOLOGY CHINA, Heshan City Jiangmen Guangdong (CN)

(72) Inventors: Kwok fong WONG, Heshan City Jiangmen (CN); Pui yi CHING, Heshan City Jiangmen (CN)

(21) Appl. No.: 14/648,554

(22) PCT Filed: Feb. 17, 2013
(86) PCT No.: PCT/CN2013/071615

§ 371 Date: May 29, 2015

(30) Foreign Application Priority Data
Dec. 3, 2012 (CN) 201210508008.X

(51) Int. Cl. H04L 29/06; G06F 17/30; G06F 21/32; G06K 9/00

(52) U.S. Cl. CPC H04L 63/0861; G06K 9/00087; G06F 17/3028; G06F 21/32; H04L 63/0428

(57) ABSTRACT

The invention discloses an image management system and method based on fingerprint authentication, and belongs to the field of communication technology. The system comprises a fingerprint sensing device and an information exchange platform. The fingerprint sensing device is used for extracting the first fingerprint information of a user at a first terminal and encrypting an image according to the first fingerprint information. The information exchange platform is used for sending the first fingerprint information to a second terminal, such that the second terminal decrypts the image according the first fingerprint formation to obtain the decrypted image. The system and method greatly improve the privacy of the image of the user, and improve the security of the image.

### FIELD OF THE INVENTION

The invention relates to the filed of communication technology, and more particularly to an image management system and an image management method based on fingerprint authentication.

### DESCRIPTION OF THE RELATED ART

With the extensive use of network, people like to store their photos or their favorite photos on the internet. However, due to the openness of the internet, some private photos are easily downloaded and spread by others because a password is not provided by a end-user or the password is leaked, and thus the legal benefits of the user is damaged and the user will face enormous threaten on privacy and security.

### SUMMARY OF THE INVENTION

In order to solve the above technical problem of the prior art, the embodiments of the invention provide an image management system and an image management method based on fingerprint authentication.

The invention utilizes the following technical solutions.

In one aspect, the invention provides an image management system based on fingerprint authentication, the system comprises a fingerprint sensing device and an information exchange platform.

The fingerprint sensing device is used for extracting the first fingerprint information of a user at a first terminal, and encrypting an image according to the first fingerprint information.

The information exchange platform is used for sending the first fingerprint information to a second terminal, such that the second terminal decrypts the image according to the first fingerprint information to obtain the decrypted image.

In another aspect, the invention provides an image management method, the method comprise the steps of:
extracting the first fingerprint information of a user at a first terminal by a fingerprint sensing device, and encrypting an image according to the first fingerprint information; and
sending the first fingerprint information to a second terminal by an information exchange platform, such that the second terminal decrypts the image according to the first fingerprint information to obtain the decrypted image.

The invention has the following advantages by utilizing the technical solutions of the embodiments:

the fingerprint sensing device encrypts the image according to the first fingerprint information of the user at the first terminal, and the information exchange platform sends the first fingerprint information to the second terminal, the encryption and decryption management of the images is achieved by means of the fingerprint information of the user, such that any end-user not authenticated by the first terminal can not look over the images encrypted by the first terminal, thereby ensuring the privacy of the images of the user at the first terminal, and improving the security of images.

### BRIEF DESCRIPTION OF THE DRAWINGS

In order to illustrate more clearly the technical solutions of the embodiments of the invention, the drawings used in the embodiments will be described simply hereinafter. Obviously, the drawings are given by way of example, and for a person skilled in the art, other equivalent drawings can be obtained according to these drawings without any creative work.

FIG. 1 is a schematic drawing of an image management system based on fingerprint authentication according to embodiment 1 of the invention;

FIG. 2 is a schematic drawing of an image management system based on fingerprint authentication according to embodiment 2 of the invention;

FIG. 3 is a flow chart of an image management method according to embodiment 3 of the invention;

FIG. 4 is a flow chart of an image management method according to embodiment 4 of the invention; and

FIG. 5 is a flow chart of an image management method according to embodiment 5 of the invention.

### DETAILED DESCRIPTION OF THE INVENTION

In order to make the object, technical solutions and advantages of the invention more clearly, the embodiments will be described hereinafter in more detail in connection with drawings.

### Embodiment 1

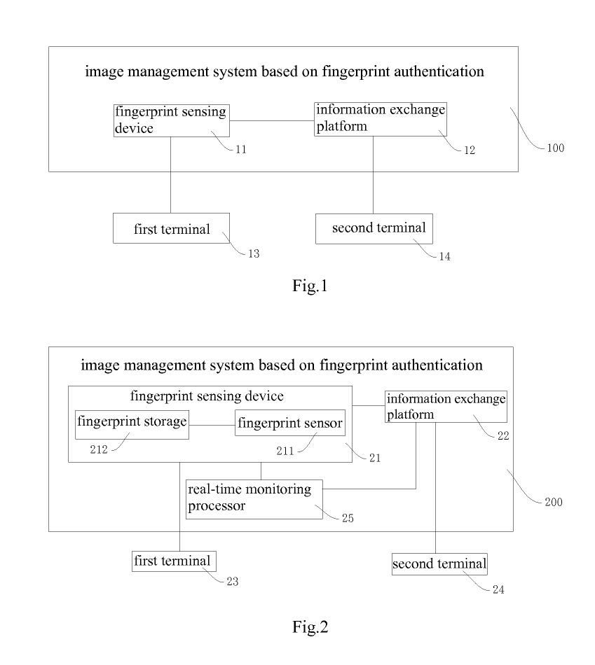

FIG. 1 is a schematic drawing of an image management system based on fingerprint authentication according to embodiment 1 of the invention. As shown in FIG. 1, the image management system 100 based on fingerprint authentication of the embodiment 1 of the invention specifically comprises a fingerprint sensing device 11 and an information exchange platform 12.

The fingerprint sensing device 11 extracts the first fingerprint information of a user at a first terminal 13, and encrypts an image according to the first fingerprint information. The information exchange platform sends the first fingerprint information to a second terminal 14, such that the second terminal decrypts the image according to the first fingerprint information to obtain the decrypted image.

In the image management system based on fingerprint authentication provided by the embodiment 1 of the invention, the fingerprint sensing device 11 encrypts the image according to the first fingerprint information of the user at the first terminal 13, and the information exchange platform 12 sends the first fingerprint information to the second terminal 14, the encryption and decryption management of the images is achieved by means of the fingerprint information of the user, such that any end-user not authenticated by the first terminal 13 can not look over the images encrypted by the first terminal 13, thereby ensuring the privacy of the images of the user at the first terminal 13, and improving the security of images.

### Embodiment 2

FIG. 2 is a schematic drawing of an image management system based on fingerprint authentication according to embodiment 2 of the invention. As shown in FIG. 2, the image management system 200 based on fingerprint authentication of the embodiment 2 of the invention specifically comprises a fingerprint sensing device 21, an information exchange platform 22 and a real-time monitoring processor 25.

The fingerprint sensing device 21 extracts the first fingerprint information of a user at a first terminal 23, and encrypts an image according to the first fingerprint information. The information exchange platform 22 sends the first fingerprint information to a second terminal 24, such that the second terminal 24 decrypts the image according to the first fingerprint information to obtain the decrypted image. If the first terminal 23 sends a plurality of images on the Internet and the fingerprint sensing device 21 encrypts part of the plurality of images, then the real-time monitoring processor 25 encrypts unencrypted images of the plurality of images in the course of sending the plurality of images, and sends the decryption key thereof to the information exchange platform.

Preferably, when the user at the first terminal 23 needs to add a user at the second terminal 24 as a friend, the information exchange platform 22 sends the first fingerprint information and a request of adding a friend from the first terminal 23 to the second terminal 24, after the confirmation of the user at the second terminal 24, the fingerprint sensing device 21 extracts a second fingerprint information of the user at the second terminal 24.

Preferably, the fingerprint sensing device 21 also can encrypt or decrypt the plurality of images individually or in batches according to the first fingerprint information. Preferably, the fingerprint sensing device 21 also may comprise a fingerprint sensor 211 and a fingerprint storage 212, wherein the fingerprint sensor 211 extracts the first fingerprint information of the user at the first terminal, and the fingerprint storage 212 stores the first fingerprint information extracted by the fingerprint sensor.

In the image management system based on fingerprint authentication provided by the embodiment 2 of the invention, the fingerprint sensing device 21 encrypts the image according to the first fingerprint information of the user at the first terminal 23, and the information exchange platform 22 sends the first fingerprint information to the second terminal 24, the encryption and decryption management of the images is achieved by means of the fingerprint information of the user, such that any end-user not authenticated by the first terminal 23 can not look over the images encrypted by the first terminal 23, thereby ensuring the privacy of the images of the user at the first terminal 23, and improving the security of images.

### Embodiment 3

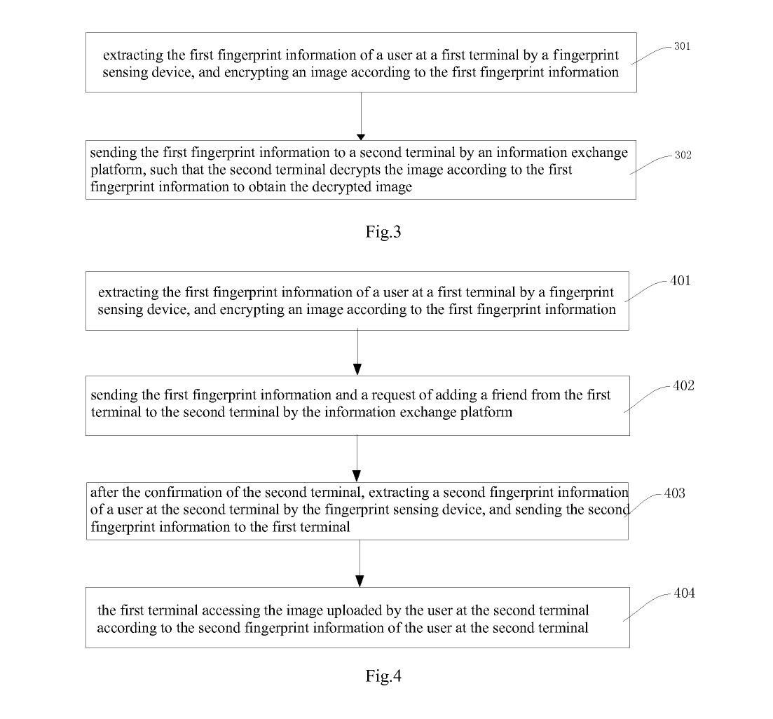

FIG. 3 is a flow chart of an image management method according to embodiment 3 of the invention, and the embodiment 3 can be implemented by the embodiments shown in FIGS. 1 and 2. As shown in FIG. 3, the embodiment 3 of the invention comprises the following steps:

step 301: extracting the first fingerprint information of a user at a first terminal by a fingerprint sensing device, and encrypting an image according to the first fingerprint information; and
step 302: sending the first fingerprint information to a second terminal by an information exchange platform, such that the second terminal decrypts the image according to the first fingerprint information to obtain the decrypted image.

In the image management method based on fingerprint authentication provided by the embodiment 3 of the invention, the fingerprint sensing device encrypts the image according to the first fingerprint information of the user at the first terminal, and the information exchange platform sends the first fingerprint information to the second terminal, the encryption and decryption management of the images is achieved by means of the fingerprint information of the user, such that any end-user not authenticated by the first terminal can not look over the images encrypted by the first terminal, thereby ensuring the privacy of the images of the user at the first terminal, and improving the security of images.

### Embodiment 4

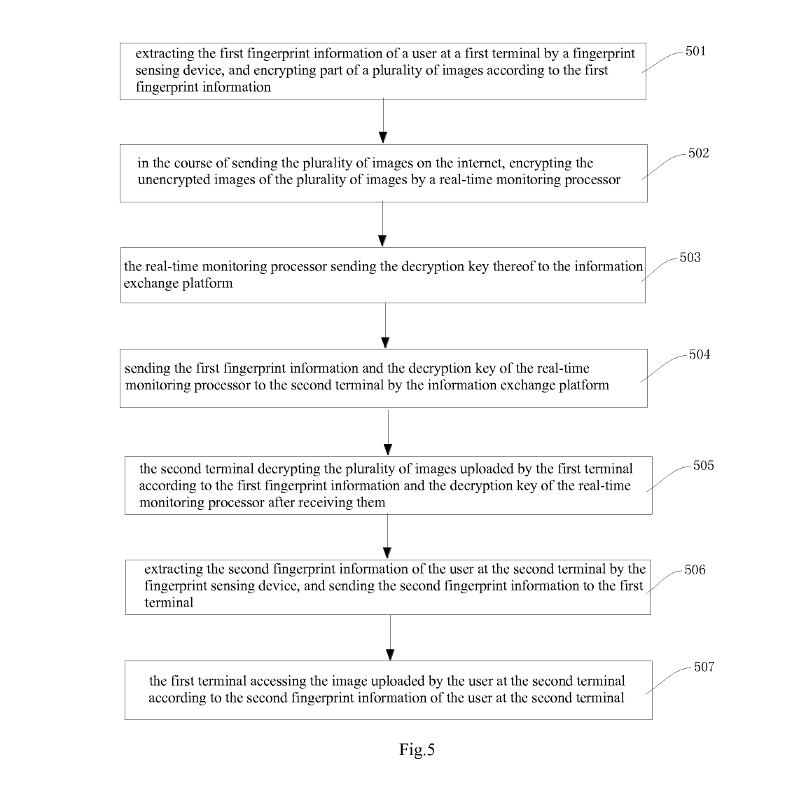

FIG. 4 is a flow chart of an image management method based on fingerprint authentication according to embodiment 4 of the invention, and the embodiment 4 can be implemented by the embodiments shown in FIGS. 1 and 2. As shown in FIG. 4, when the user at the first terminal needs to add the user at the second terminal as a friend, the embodiment 4 of the invention comprises the following steps:

step 401: extracting the first fingerprint information of a user at a first terminal by a fingerprint sensing device, and encrypting an image according to the first fingerprint information.

In the step 401, the image of this embodiment specifically may be the head portrait of the user at the first terminal utilizing the relevant applications or any other image to be uploaded.

step 402: sending the first fingerprint information and a request of adding a friend from the first terminal to the second terminal by the information exchange platform.
step 403: after the confirmation of the second terminal, extracting a second fingerprint information of a user at the second terminal by the fingerprint sensing device, and sending the second fingerprint information to the first terminal.
step 404: the first terminal accessing the image uploaded by the user at the second terminal according to the second fingerprint information of the user at the second terminal.

By means of the above steps 401-404, the user at the first terminal and the user at the second terminal successfully add friends with each other, and successfully exchange the keys of them.

In the image management method based on fingerprint authentication provided by the embodiment 4 of the invention, the fingerprint sensing device encrypts the image according to the first fingerprint information of the user at the first terminal, and the information exchange platform sends the first fingerprint information to the second terminal, the encryption and decryption management of the images is achieved by means of the fingerprint information of the user, such that any end-user not authenticated by the first terminal can not look over the images encrypted by the first terminal, thereby ensuring the privacy of the images of the user at the first terminal, and improving the security of images.

### Embodiment 5

FIG. 5 is a flow chart of an image management method according to embodiment 5 of the invention, and the embodiment 5 can be implemented by the embodiments shown in FIGS. 1 and 2. As shown in FIG. 5, this embodiment 5 of the invention is described by way of example in the case that the user at the first terminal and the user at the second terminal have been friends without exchanging the keys, and this embodiment 5 comprises the following steps:

step 501: extracting the first fingerprint information of a user at a first terminal by a fingerprint sensing device, and encrypting part of a plurality of images according to the first fingerprint information.

In the step 501, the image of this embodiment specifically may be the head portrait of the user at the first terminal utilizing the relevant applications or any other image to be uploaded.

step 502: in the course of sending the plurality of images on the internet, encrypting the unencrypted images of the plurality of images by a real-time monitoring processor.
step 503: the real-time monitoring processor sending the decryption key thereof to the information exchange platform.
step 504: sending the first fingerprint information and the decryption key of the real-time monitoring processor to the second terminal by the information exchange platform.
step 505: the second terminal decrypting the plurality of images uploaded by the first terminal according to the first fingerprint information and the decryption key of the real-time monitoring processor after receiving them.
step 506: extracting the second fingerprint information of the user at the second terminal by the fingerprint sensing device, and sending the second fingerprint information to the first terminal.
step 507: the first terminal accessing the image uploaded by the user at the second terminal according to the second fingerprint information of the user at the second terminal.

A person skilled in the art should appreciate that, the above first terminal and the second terminal specifically may be mobile devices, such as a mobile phone and a tablet computer. Furthermore, in the specific applications, the first and second terminals are described only for distinguishing, and the first and second terminals can be configured as the same or different types of mobile devices as long as they can make the end-users contact with each other by the corresponding application services (such as, WeChat, microblog and the like).

In the image management method based on fingerprint authentication of the embodiment 5 of the invention, in the course of sending a plurality of images on the internet, the unencrypted images of the plurality of images are encrypted by the real-time monitoring processor, thus the security of the photos stored on the internet is improved, and the user doesn't need to worry about any adverse effects after the images are stolen. Furthermore, by encrypting the part of the images, the users can display their images (such as, a photo) to others as required, thereby improving the security and privacy of the user.

More preferably, in the above embodiments 3 to 5, the user at the first terminal also can encrypt or decrypt the images stored on the internet (an internet server) or at the first terminal individually or in batches, and send them to a third part.

It needs to be further noted that, the information exchange platform of the above embodiments 1 to 5 may be a host device or an internet server, mainly for exchanging the fingerprint information between terminals to exchange keys. The application may specifically be various real-time or non-real-time chat application softwares, also may be other applications which can store various types of images. The images may be a head portrait, or an image stored on the internet, or images which are stored on the local of the user and can be sent to any third party, this is not limited by the embodiments of the invention.

In conclusion, in the embodiments of the invention, the image is encrypted by the fingerprint information, and thus the various requirements on image treatment of user can be met, the security of the images stored on the internet is improved, and the user doesn't need to worry about any adverse effects after the images are stolen.

Furthermore, the user also can display their photos to other authorized users as required, thereby improving the privacy while improving the security, as well as ensuring the enjoyment in some extent.

It should be noted that: in the above embodiments, the partition of the above functional modules are illustrated by way of example, in practical applications, the above functions can be achieved by different functional modules as required, that is to say, the inner structure of the system is divided into different functional modules, to reach the whole or part of the functions as described above. Furthermore, the fingerprint authentication systems provided by the above embodiments and the fingerprint authentication methods belong to the same technical conception, and the specific implementation process of these systems can be detailedly seen in method embodiments, and thus will not be described here in more detail.

The numberings of the embodiments are given only for description, instead of representing the quality of the embodiments.

A person skilled in the art shall appreciate that, part or all of the steps achieving the above embodiments can be completed by means of hardware, or by instructing related hardware via a program, and the program may be stored in a computer-readable storage medium which may be a read only memory, magnetic disk or optical disc or the like.

The preferred embodiments as above described are not intended for limiting of the invention, any variations, equivalent substitutions, improvement within the spirit and scope of the invention are contained in the extent of protection of the invention.

1. An image management system based on fingerprint authentication comprising:
a fingerprint sensing device for extracting the first fingerprint information of a user at a first terminal, and encrypting an image according to the first fingerprint information; and
an information exchange platform for sending the first fingerprint information to a second terminal, such that the second terminal decrypts the image according to the first fingerprint information to obtain the decrypted image.

2. The image management system based on fingerprint authentication as claimed in claim 1, wherein when the user at the first terminal needs to add a user at the second terminal as a friend,
the information exchange platform is also used for sending the first fingerprint information and a request of adding a friend from the first terminal to the second terminal; and
after the confirmation of the user at the second terminal, the fingerprint sensing device is also used for extracting a second fingerprint information of the user at the second terminal.

3. The image management system based on fingerprint authentication as claimed in claim 1, wherein the fingerprint sensing device is also used for encrypting and decrypting a plurality of images individually or in batches according to the first fingerprint information.

4. The image management system based on fingerprint authentication as claimed in claim 1, wherein the system also comprises a real-time monitoring processor, which is used for encrypting the unencrypted images of a plurality of images in the course of sending the plurality of images when the first terminal transmits the plurality of images on the Internet and the fingerprint sensing device encrypts part of the plurality of images, used, and for sending a decryption key thereof to the information exchange platform.

5. The image management system based on fingerprint authentication as claimed in claim 1, wherein the fingerprint sensing device comprises a fingerprint sensor for extracting the first fingerprint information of the user at the first terminal and a fingerprint storage for storing the first fingerprint information extracted by the fingerprint sensor.

6. An image management method based on fingerprint authentication comprising the steps of:
extracting the first fingerprint information of a user at a first terminal by a fingerprint sensing device, and encrypting an image according to the first fingerprint information; and
sending the first fingerprint information to a second terminal by an information exchange platform, such that the second terminal decrypts the image according to the first fingerprint information to obtain the decrypted image.

7. The image management method based on fingerprint authentication as claimed in claim 6, wherein when the user at the first terminal needs to add a user at the second terminal as a friend, the method also comprises the steps of:
sending the first fingerprint information and a request of adding a friend from the first terminal to the second terminal by the information exchange platform; and
extracting a second fingerprint information of a user at the second terminal by the fingerprint sensing device after the confirmation of the second terminal, such that the first terminal obtains the image uploaded by the user at the second terminal according to the second fingerprint information.

8. The image management method based on fingerprint authentication as claimed in claim 6, wherein the method also comprises encrypting a plurality of images individually or in batches by the fingerprint sensing device according to the first fingerprint information.

9. The image management method based on fingerprint authentication as claimed in claim 6, wherein when the first terminal sends a plurality of images on the Internet, the method also comprises:
encrypting the unencrypted images of the plurality of images in the course of sending the plurality of images by a real-time monitoring processor if part of the plurality of images are encrypted by the fingerprint sensing device; and
the real-time monitoring processor sending the decryption key thereof to the information exchange platform.

10. The image management method based on fingerprint authentication as claimed in claim 6, herein the step of extracting the first fingerprint information of a user at a first terminal by a fingerprint sensing device also comprises:
extracting the first fingerprint information of the user at the first terminal by a fingerprint sensor; and
storing the first fingerprint information extracted by the fingerprint sensor by a fingerprint storage.

11. The image management system based on fingerprint authentication as claimed in claims 2, wherein the fingerprint sensing device comprises a fingerprint sensor for extracting the first fingerprint information of the user at the first terminal and a fingerprint storage for storing the first fingerprint information extracted by the fingerprint sensor.

12. The image management system based on fingerprint authentication as claimed in claims 3, wherein the fingerprint sensing device comprises a fingerprint sensor for extracting the first fingerprint information of the user at the first terminal and a fingerprint storage for storing the first fingerprint information extracted by the fingerprint sensor.

13. The image management system based on fingerprint authentication as claimed in claims 4, wherein the fingerprint sensing device comprises a fingerprint sensor for extracting the first fingerprint information of the user at the first terminal and a fingerprint storage for storing the first fingerprint information extracted by the fingerprint sensor.

14. The image management method based on fingerprint authentication as claimed in claim 7, wherein the step of extracting the first fingerprint information of a user at a first terminal by a fingerprint sensing device also comprises:
extracting the first fingerprint information of the user at the first terminal by a fingerprint sensor; and
storing the first fingerprint information extracted by the fingerprint sensor by a fingerprint storage.

15. The image management method based on fingerprint authentication as claimed in claim 8, wherein the step of extracting the first fingerprint information of a user at a first terminal by a fingerprint sensing device also comprises:
extracting the first fingerprint information of the user at the first terminal by a fingerprint sensor; and
storing the first fingerprint information extracted by the fingerprint sensor by a fingerprint storage.

16. The image management method based on fingerprint authentication as claimed in claim 9, wherein the step of extracting the first fingerprint information of a user at a first terminal by a fingerprint sensing device also comprises:
extracting the first fingerprint information of the user at the first terminal by a fingerprint sensor; and
storing the first fingerprint information extracted by the fingerprint sensor by a fingerprint storage.
